(19) United States
(12) Patent Application Publication
(10) Pub. No.: US 2011/0051174 A1
(43) Pub. Date: Mar. 3, 2011

(54) METHOD OF QUERYING IMAGE OUTPUT DEVICES ON A NETWORK

(76) Inventor: Tomoki HATTORI, Duluth, GA (US)

(21) Appl. No.: 12/547,215

(22) Filed: Aug. 25, 2009

(51) Int. Cl. G06F 17/30

(52) U.S. Cl. 358/1.15; 707/E17.014; 707/E17.019; 709/230; 709/217; 707/708; 707/737

(57) ABSTRACT

A method of querying image output devices on a network, including receiving a search term indicating device-related information to be searched. The method includes first determining whether the search term includes a target device type, and if the first determining step determines that the search term includes the target device type, determining which devices in a list of all devices on the network are of the target device type to generate a device list. Otherwise the device list is set to be the list of all devices on the network. The method further includes second determining if the search term includes a conditional expression, and if the second determining step determines that the search term includes a conditional expression, determining which devices in the device list satisfy the conditional expression, so as to generate a final list of devices. The final list of devices is displayed.

### FIELD OF THE INVENTION

This invention relates to querying printing devices, multifunction devices, copiers, image forming apparatuses, image output devices, and document management devices configured in networks for device-related information.

### DISCUSSION OF THE BACKGROUND

Printing devices and multifunction devices, such as copiers, scanners, multifunction printers, fax machines and other document management devices are commonly used in large network systems. Some large organizations, including corporations and universities, use as many as tens of thousands of such devices in a network configuration. Currently, there exist management tools that can manage, monitor, and configure network devices having plug-in capabilities. Conventional software applications may be used to manage and/or to acquire information from devices on a network, but they do not provide a very flexible user interface.

Further, Google or Yahoo can be used to search a website. Google Desktop is a desktop search application made by Google for Mac OS X, Linux, and Microsoft Windows. The program allows text searches of a user's e-mails, computer files, music, photos, chats, Web pages viewed, and other “Google Gadgets.” After initially installing Google Desktop, the software completes an indexing of all the files in the computer. And after the initial indexing is completed, the software continues to index files as needed. Users can start searching for files immediately after installing the program. After performing searches, results can also be returned in an Internet browser on the Google Desktop Home Page much like the results for Google Web searches.

Conventional user interfaces, such as Google or Yahoo, are simple to operate. For example, a user types in a plurality of characters, a name of a newspaper, or the topic that the user wants to read about from a website, to gain access to corresponding information. However, this conventional type of user interface is unable to perform device management in a convenient, user-friendly way. Indeed, different management tools are needed for different types of devices. That is, in order to acquire content information from a device, a user must click on certain functions in the user interface and usually several clicks are necessary in order to get device-related information from the user interface. Further, a user needs to know which protocol to use with each device, and must switch between different software applications to communicate with different devices. For example, management tool A might only provide a communication method using SNMP, but software B provides a plug-in using a different protocol. Further, plug-in capability does not provide a universal console user interface, so that if a user adds a plug-in, another user interface is necessary.

What is needed is an application that simplifies the process of extracting information from network devices in a convenient and user-friendly way, that is transparent to the user, and that reduces user operation time.

### SUMMARY OF THE INVENTION

The invention broadly provides a method and apparatus for querying image output devices on a network, including receiving a search term indicating device-related information to be searched. The method includes first determining whether the search term includes a target device type, and if the first determining step determines that the search term includes the target device type, determining which devices in a list of all devices on the network are of the target device type to generate a device list. If the search term does not include a target device type, then the device list is set to be the list of all devices on the network. The method further includes second determining if the search term includes a conditional expression, and if the second determining step determines that the search term includes a conditional expression, determining which devices in the device list satisfy the conditional expression, so as to generate a final list of devices. The final list of devices is displayed to a user.

In one aspect, the step of determining which devices in the list of all devices are the target device type comprises searching a database to determine, based on the target device type, a communication protocol and corresponding protocol command for sending to each of the devices on the network; sending the protocol command to each device in the list of all devices on the network; receiving a response from each device in the list of all devices on the network; and parsing the response to determine the device list.

In another aspect, the searching step comprises searching a target table listing target device types for a word matching the target device type, the target device type including a printer, a scanner, a facsimile, a copier, and a multifunction printer; searching a target search command table for the protocol command used to identify a target device type; and storing each identified device in a temporary table.

In a further embodiment, the sending step comprises sending the protocol command to an assigned protocol plug-in and running the protocol command in a command set with an argument/parameter command.

In another embodiment, the parsing step comprises generating a temporary table for each and a result of the temporary tables is evaluated by a union or by an intersection of the all temporary tables that are generated.

In another embodiment, the steps of sending the protocol message comprises sending the protocol message using a SNMP, PJL, SOAP, and HTTP protocol.

In a further embodiment, the first determining step comprises searching at least one of a primary word table and a synonym table for at least one term in the search term.

Moreover, the invention also broadly comprises generating a spreadsheet of the final list of devices for interfacing with a Google desktop environment.

In one embodiment, the search term is parsed into a search key and a condition used to query the devices.

In some aspects, the invention also includes generating the list of all devices on the network by performing a multi-cast Domain Name System query.

In alternative embodiments, the invention broadly comprises a computer readable storage medium encoded with a computer readable program configured to cause an information processing apparatus to execute a method, including receiving a search term indicating device-related information to be searched. The method includes first determining whether the search term includes a target device type, and if the first determining step determines that the search term includes the target device type, determining which devices in a list of all devices on the network are of the target device type to generate a device list. If the search term does not include a target device type, then the device list is set to be the list of all devices on the network. The method further includes second determining if the search term includes a conditional expression, and if the second determining step determines that the search term includes a conditional expression, determining which devices in the device list satisfy the conditional expression, so as to generate a final list of devices. The final list of devices is displayed to a user.

In another embodiment, the invention broadly comprises a system for querying image output devices on a network. The system includes means for receiving a search term, and parsing means for parsing the received search term. The system further includes first determining means for first determining whether the search term includes a target device type and determining whether the search term includes a conditional expression. If the first determining means determines that the search term includes the target device type, the first determining means determines which devices in a list of all devices on the network are of the target device type to generate a device list; otherwise the device list is set to be the list of all devices on the network. The system further includes second determining means for second determining if the search term includes a conditional expression. If the second determining means determines that the search term includes a conditional expression, the second determining means determines which devices in the device list satisfy the conditional expression, so as to generate a final list of devices. A display component is configured to display the final list of devices.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a schematic diagram of a management device communicating with image output devices on a network having Subnet 1 and Subnet 2, for example;

FIG. 2 is a schematic diagram of the management device depicted in FIG. 1;

FIG. 3 is a schematic diagram of the computer system of the management device depicted in FIG. 1;

FIGS. 4A-C is a flowchart of an operation flow of the management device querying image output devices on a network;

FIG. 5 is a flowchart of the parsing step shown in FIG. 4A;

FIG. 6 is a flowchart illustrating the process of parsing the data received from accessing a device;

FIG. 7 is a flowchart of the displaying the search result step in FIG. 4C;

FIG. 8 is a flowchart of the sending step in FIGS. 4A and 4B, for example;

FIGS. 9A and 9B is a flowchart of the determining a protocol in FIGS. 4A and 4B;

FIG. 10 illustrates an example of a Target Table, a Word Table, and a Synonym Table;

FIG. 11 illustrates an example of a Windows Explorer type interface;

FIG. 12 illustrates an example of a spreadsheet generated by a user to interface with a Google desktop environment; and

FIG. 13 is a block diagram showing the schematic configuration of a system structure according to one embodiment of the invention.

FIG. 14 illustrates another example of search results that are displayed within the Google desktop environment.

### DETAILED DESCRIPTION OF THE PREFERRED EMBODIMENTS

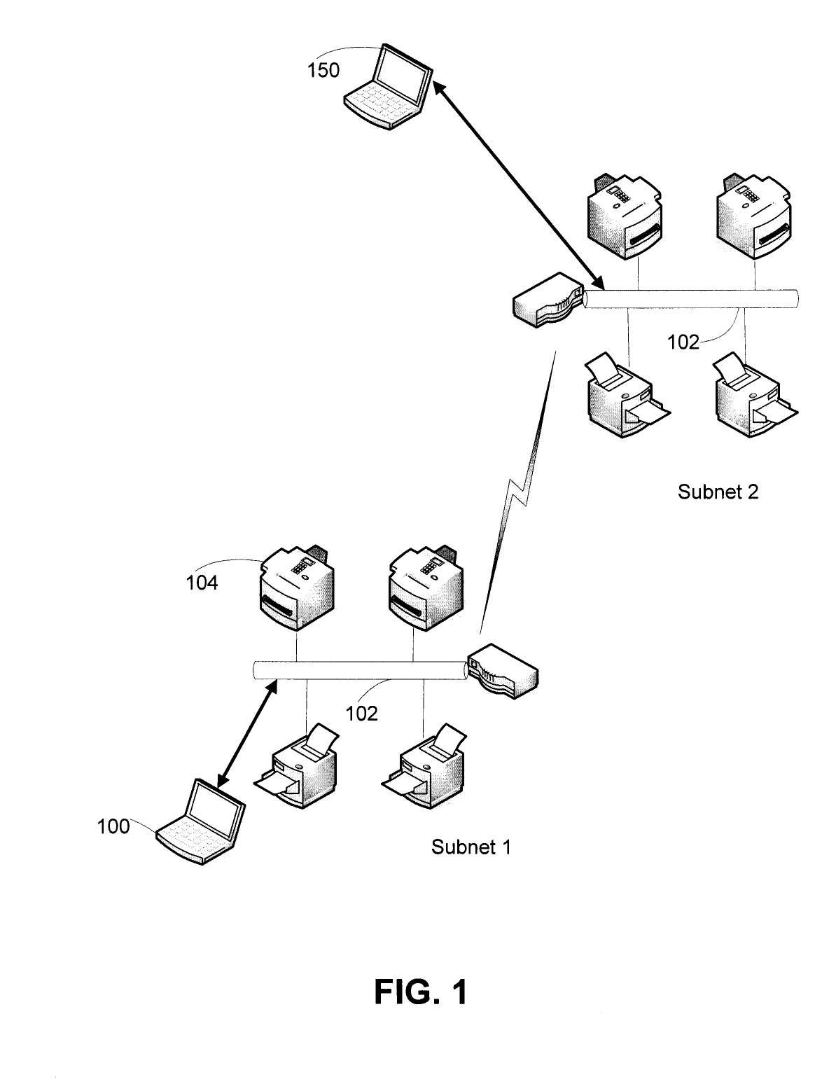

Referring to the drawings, wherein like reference numerals designate identical or corresponding parts throughout the several views, FIG. 1 shows a management device (MD) 100 communicating with an image output device 104, for example, via a network connection 102. The MD 100 is a workstation, such as a personal computer having a keyboard and a display. Preferably the MD 100 includes a network adapter, such as an Ethernet adapter or a wireless Ethernet adapter according to one of the IEEE network communication standards. For example, a TCP/IP controller for a 10/100/1000 Mbit/s Ethernet controller in accordance with the IEEE 802.3 LAN protocol, or a network controller in accordance with one of the wireless networking IEEE protocols 802.11b, 802.11g, or 802.11n. The network connection 102, in one embodiment, is a category five (Cat5 or Cat5e) cable in accordance with the IEEE 802.3 protocol, although any type of communication protocol or medium can be used, including wired, wireless or optical, for example. Additionally, in other embodiments, IEEE 1284, IEEE 1394, Bluetooth® or USB is used.

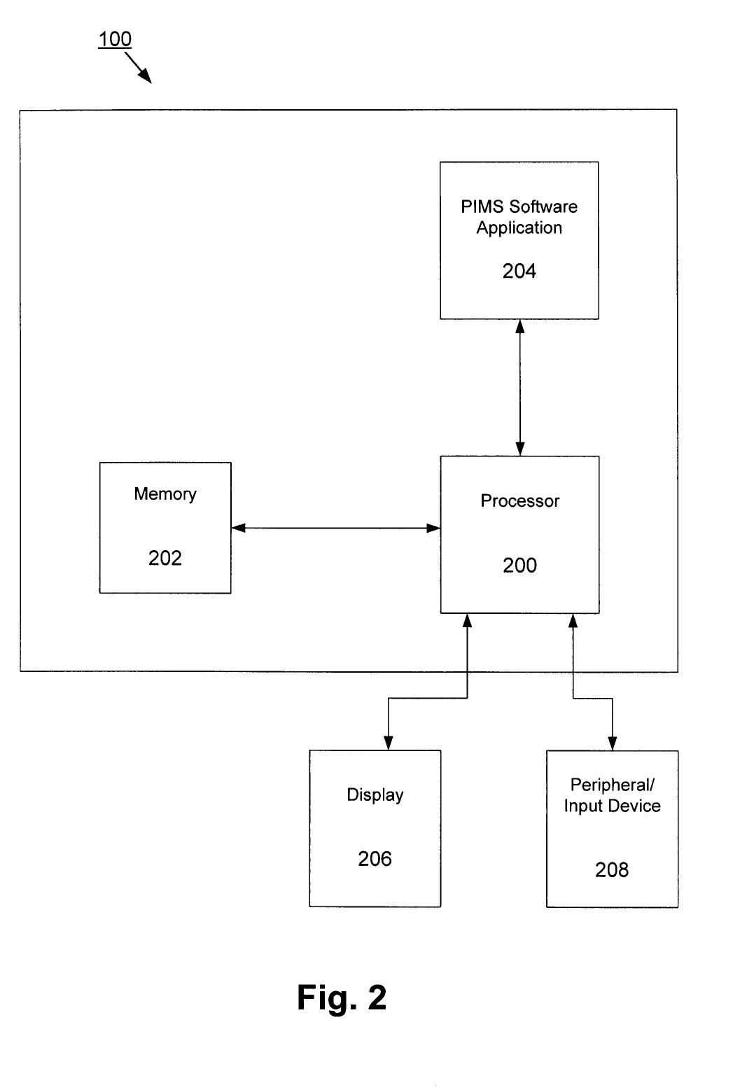

As shown in FIG. 2, the MD 100 also preferably includes a processor 200 connected to a memory 202 and is configured to execute a Printer Information Management System (PIMS) software application 204, and is configured to connect to a network and an image output device 104 or multifunction printer. The MD 100 also preferably includes a display 206 and peripheral/input devices 208, including, but not limited to, a keyboard and a mouse.

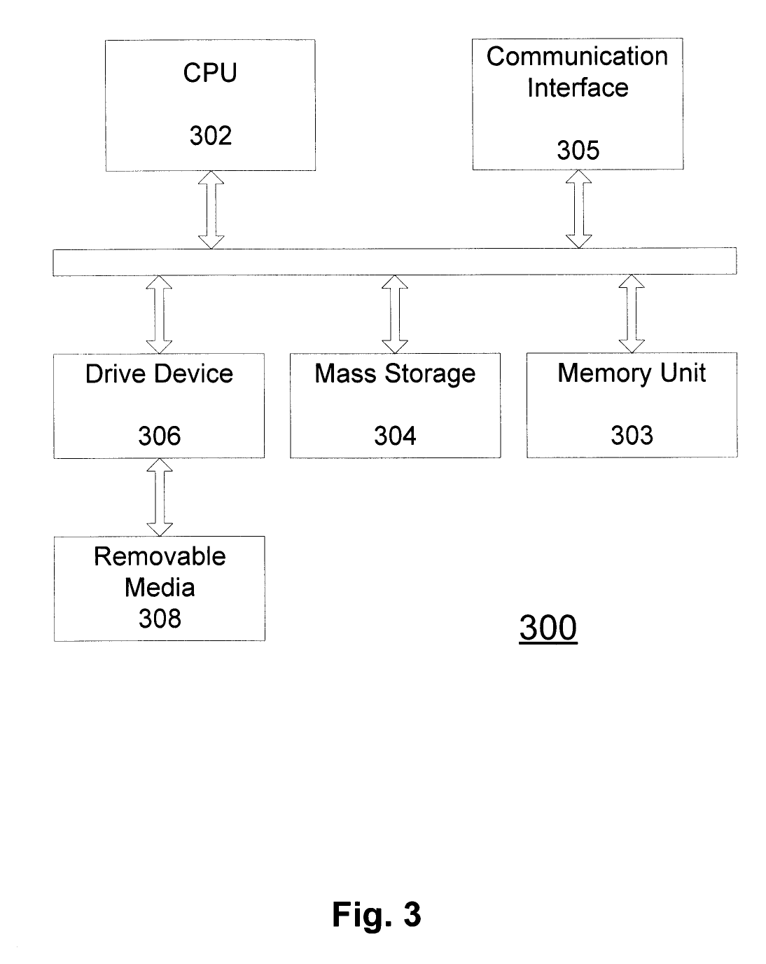

In an alternative embodiment, the PIMS software can be executed by a server 150 that is remote from the MD 100, but communicatively coupled to the network. In the alternative embodiment, the search described herein is performed by the server 150 and the results are transmitted to the MD 100 for display. The server 150 has components similar to those of the MD 100 shown in FIGS. 2 and 3.

FIG. 3 illustrates a computer system 300 in which embodiments of the PIMS software application 204 may be implemented. The PIMS software application 204 may be implemented on, for example, workstations, personal computers, laptop computers, personal digital assistants (PDAs), cellular telephone devices, or other mobile devices. The computer system 300 includes a bus B or other communication mechanism for communicating information such as address information and data, and a processor/CPU 302 coupled with the bus B for processing the information. The computer system 300 also includes a main memory unit 303, such as a random access memory (RAM) or other dynamic storage device (e.g., dynamic RAM (DRAM), static RAM (SRAM), and synchronous DRAM (SDRAM)), coupled to the bus B for storing information and instructions to be executed by the CPU 302. In addition, the memory unit 303 may be used for storing temporary variables or other intermediate information during the execution of instructions by the CPU 302. The computer system 300 may also further include a read only memory (ROM) or other static storage device (e.g., programmable ROM (PROM), erasable PROM (EPROM), and electrically erasable PROM (EEPROM)) coupled to the bus B for storing static information and instructions for the CPU 32.

The computer system 300 may also include a disk controller coupled to the bus B to control one or more storage devices for storing information and instructions, such as mass storage 304, which may be a hard disk drive, for example, and drive device 306 (e.g., floppy disk drive, read-only compact disc drive, read/write compact disc drive, compact disc jukebox, tape drive, flash memory or a flash memory based drive, and removable magneto-optical drive). The storage devices may be added to the computer system 300 using an appropriate device interface (e.g., small computer system interface (SCSI), integrated device electronics (IDE), enhanced-IDE (E-IDE), direct memory access (DMA), or ultra-DMA).

The computer system 300 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)) in order to carry out the desired functionality.

The computer system 300 may also include a display controller coupled to the bus B to control a display, such as a cathode ray tube (CRT), organic light emitting diode (OLED) display, liquid crystal display (LCD), or projector, for displaying information to a computer user. The computer system may include input devices, such as a keyboard, pointing device, or touch display, for interacting with a computer user and providing information to the processor. The pointing device, for example, may be a mouse, a trackball, or a pointing stick for communicating direction information and command selections to the processor and for controlling cursor movement on the display. In addition, a printer may provide printed listings of data stored and/or generated by the computer system.

The computer system 300 performs a portion or all of the processing steps in response to the CPU 302 executing one or more sequences of one or more instructions contained in a memory, such as the memory unit 303. Such instructions may be read into the memory unit 303 from another computer-readable medium, such as the mass storage 304 or a removable media 308. One or more processors in a multi-processing arrangement may also be employed to execute the sequences of instructions contained in the memory unit 303 or the removable media 308. In alternative embodiments, hard-wired circuitry may be used in place of or in combination with software instructions. Thus, embodiments are not limited to any specific combination of hardware circuitry and software.

As stated above, the computer system 300 includes at least one removable media 308, which is a computer-readable medium, or memory for holding instructions programmed according to the teachings described herein and for containing data structures, tables, records, or other data described herein. Examples of computer-readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other storage medium from which a computer can read.

Stored on any one or on a combination of computer-readable media is software for controlling the computer system 300, for driving a device or devices, and for enabling the computer system 300 to interact with a human user. Such software may include, but is not limited to, device drivers, operating systems, development tools, and applications software. Such computer-readable media further includes the computer program product for performing all or a portion (if processing is distributed) of the processing described herein.

The computer code devices may be any interpretable or executable code mechanism, including but not limited to scripts, interpretable programs, dynamic link libraries (DLLs), Java classes, and complete executable programs. Moreover, parts of the processing may be distributed for better performance, reliability, and/or cost.

The term “computer-readable medium” as used herein refers to any medium that participates in providing instructions to the CPU 302 for execution. A computer-readable medium may take many forms, including but not limited to, non-volatile media, and volatile media. Non-volatile media includes, for example, optical, magnetic disks, and magneto-optical disks, such as the mass storage 304 or the removable media 308. Volatile media includes dynamic memory, such as the memory unit 303.

Various forms of computer-readable media may be involved in carrying out one or more sequences of one or more instructions to the CPU 302 for execution. For example, the instructions may initially be carried on a magnetic disk of a remote computer. The remote computer can load the instructions remotely into a dynamic memory and send the instructions over a telephone line using a modem. A modem local to the computer system 300 may receive the data on the telephone line and use an infrared transmitter to convert the data to an infrared signal. An infrared detector coupled to the bus B can receive the data carried in the infrared signal and place the data on the bus B. The bus B carries the data to the memory unit 303, from which the CPU 302 retrieves and executes the instructions. The instructions received by the memory unit 33 may optionally be stored on mass storage 304 either before or after execution by the CPU 302.

The computer system 300 also includes a communication interface 305 coupled to the bus B. The communication interface 305 provides a two-way data communication coupling to a network that is connected to, for example, a LAN, or to another communications network such as the Internet. For example, the communication interface 305 may be a network interface card to attach to any packet switched LAN. As another example, the communication interface 305 may be an asymmetrical digital subscriber line (ADSL) card, an integrated services digital network (ISDN) card or a modem to provide a data communication connection to a corresponding type of communications line. Wireless links may also be implemented. In any such implementation, the communication interface 305 sends and receives electrical, electromagnetic, or optical signals that carry digital data streams representing various types of information.

The network typically provides data communication through one or more networks to other data devices. For example, the network may provide a connection to another computer through a local network (e.g., a LAN) or through equipment operated by a service provider, which provides communication services through a communications network. The local network and the communications network use, for example, electrical, electromagnetic, or optical signals that carry digital data streams, and the associated physical layer (e.g., CAT 5 cable, CAT 6 cable, coaxial cable, optical fiber, etc). The signals through the various networks and the signals on the network and through the communication interface 305, which carry the digital data to and from the computer system 300, may be implemented in baseband signals, or carrier wave based signals. The baseband signals convey the digital data as un-modulated electrical pulses that are descriptive of a stream of digital data bits, where the term “bits” is to be construed broadly to mean symbol, where each symbol conveys at least one or more information bits. Thus, the digital data may be sent as un-modulated baseband data through a “wired” communication channel and/or sent within a predetermined frequency band, different than baseband, by modulating a carrier wave. The computer system 300 can transmit and receive data, including program code, through the network and the communication interface 305. Moreover, the network may provide a connection to a mobile device such as a personal digital assistant (PDA) laptop computer, or cellular telephone.

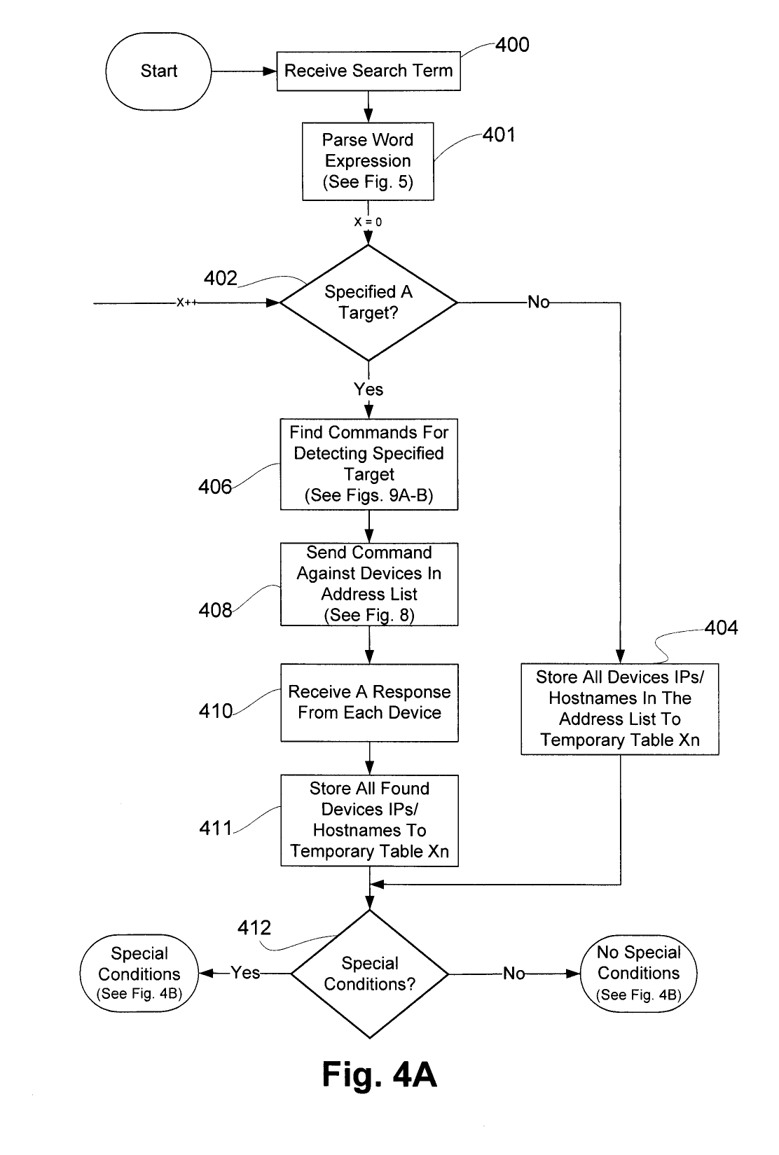

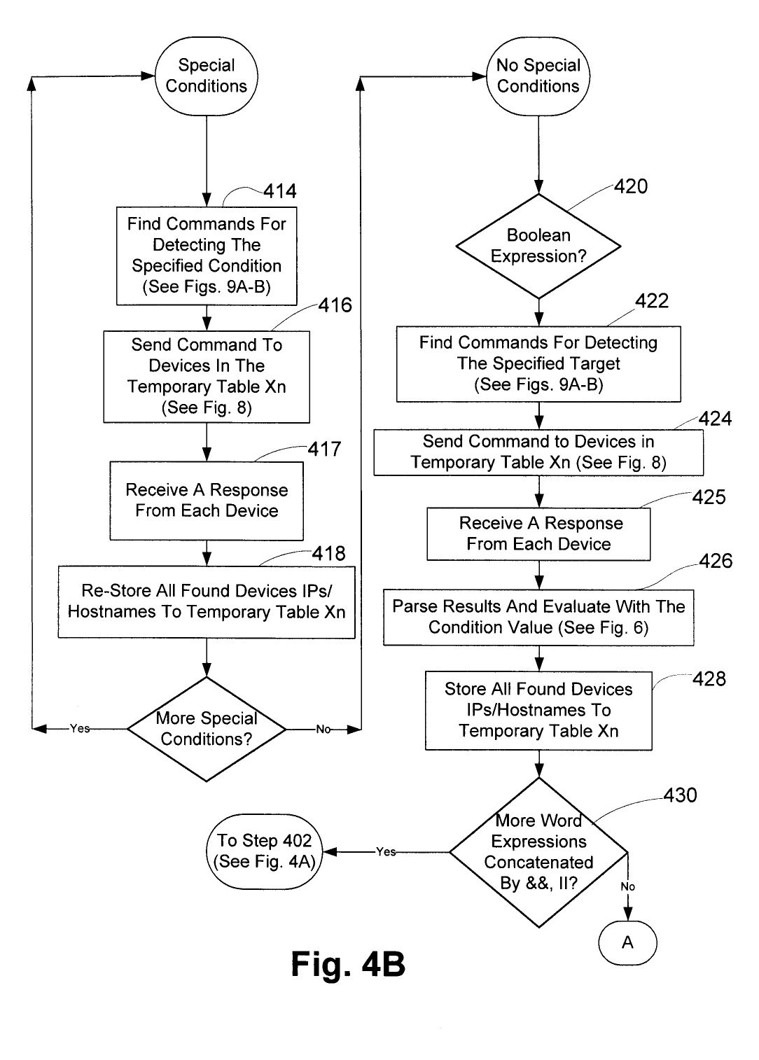

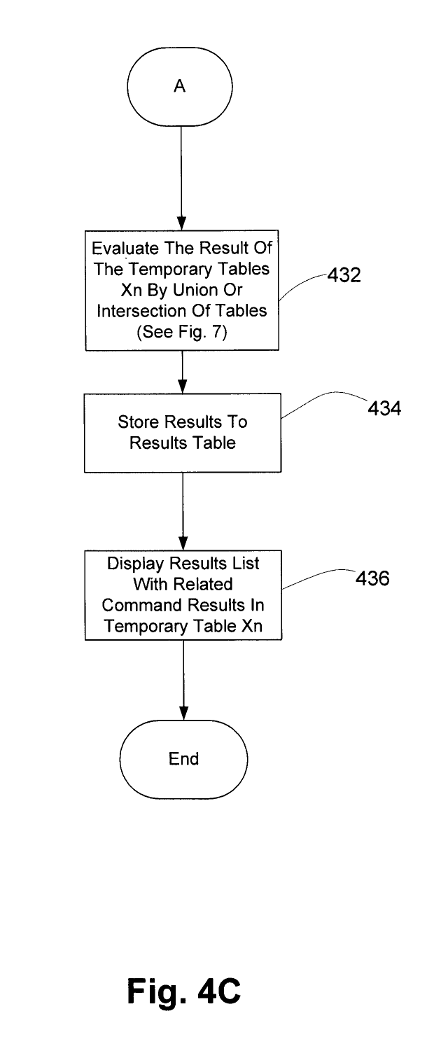

FIG. 4 shows one embodiment of a method of querying image output devices on a network. In step 400, a search term, which can include a device type and/or device-related information, is entered by a user. A search term can include one of more word expressions or word sets. The method further includes in steps 406, 414, and 422, determining, for each of the at least one search term, a corresponding communication protocol and generating a corresponding protocol message using the corresponding communication protocol. The method further includes in steps 408, 416, 424, 906, and 922, sending, for each of the at least one search term, the corresponding protocol message to each of the image input devices, and receiving, for each protocol message sent in the sending step, a corresponding response. See steps 410, 417, and 425. The method further includes in step 432, processing the received responses to generate a search result. The search result is displayed in step 436.

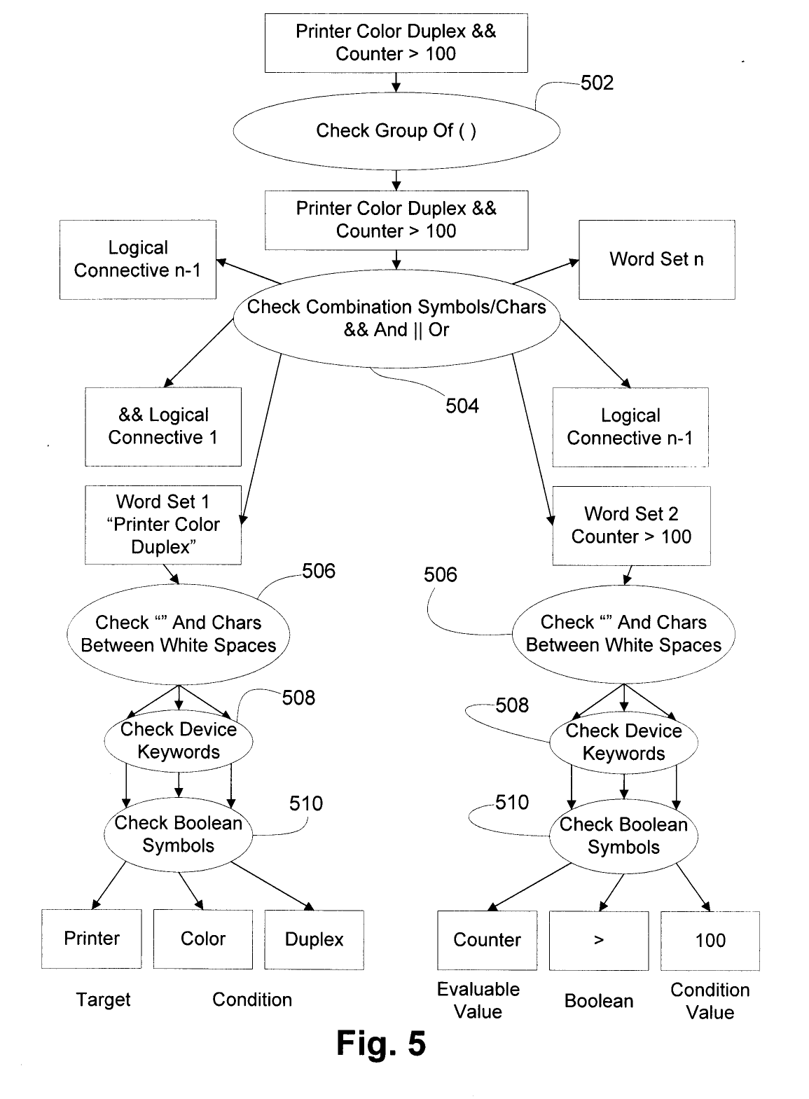

For example, suppose a search term entered by a user is “printer color duplex && counter >100,” which comprises a first word set or expression “printer color duplex” and a second word set or expression “counter >100,” as illustrated in FIG. 5. After a search term is received in step 400, the search term is parsed into its constituent word expressions in step 401. Further details of the parsing step 401 are described below with reference to FIG. 5.

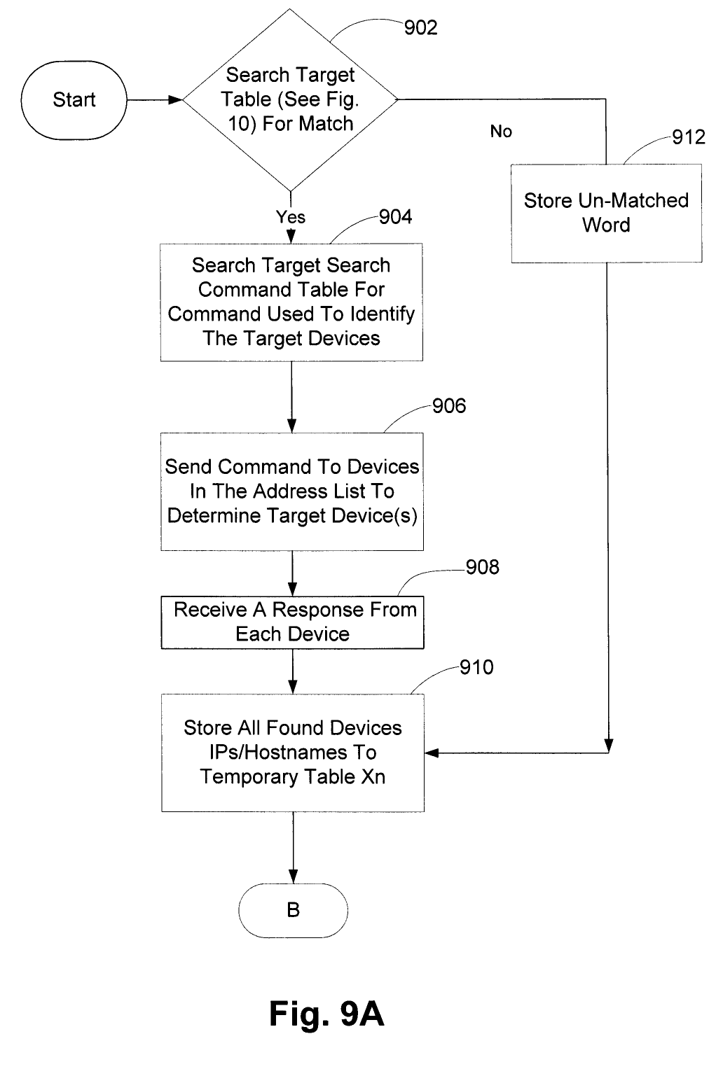

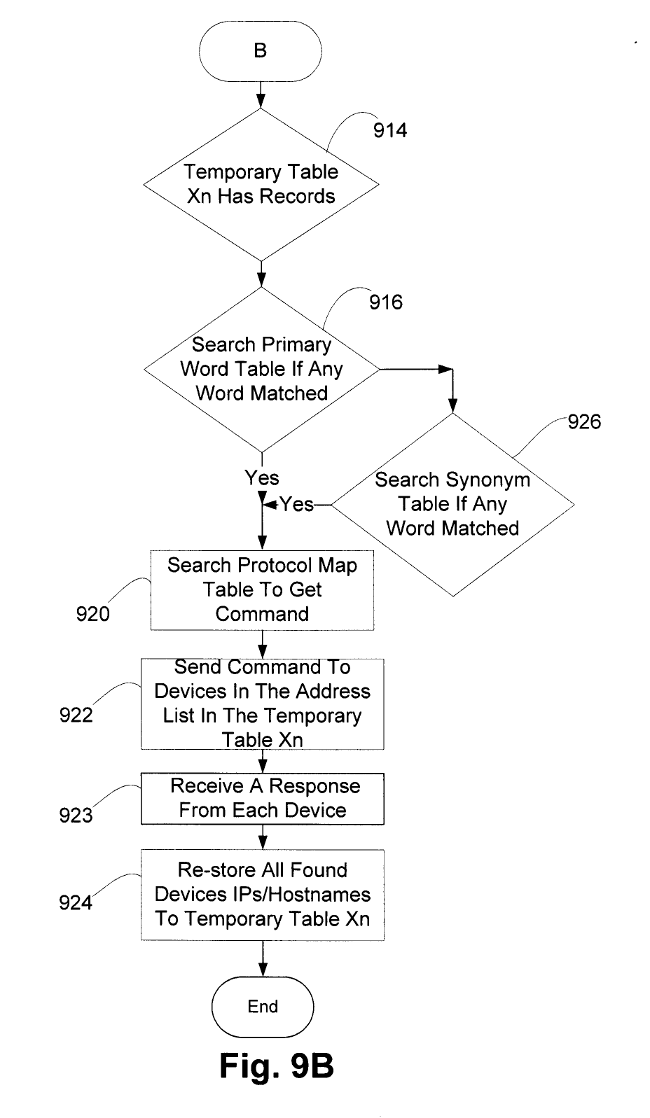

In step 402, the received search term is evaluated to determine whether a target device type has been specified. Specifying a target device, for example, includes specifying a device such as a printer, a scanner, a facsimile, a copier, and a multifunction printer. If a target device is specified, then the commands and communication protocols necessary for detecting the target devices on the network are determined in step 406. For example, if word set 1 includes the term “printer” as part of the search term, the PIMS software application checks for the commands that can be used to detect printers on the network. Further details of step 406 are described below with reference to FIGS. 9A and 9B.

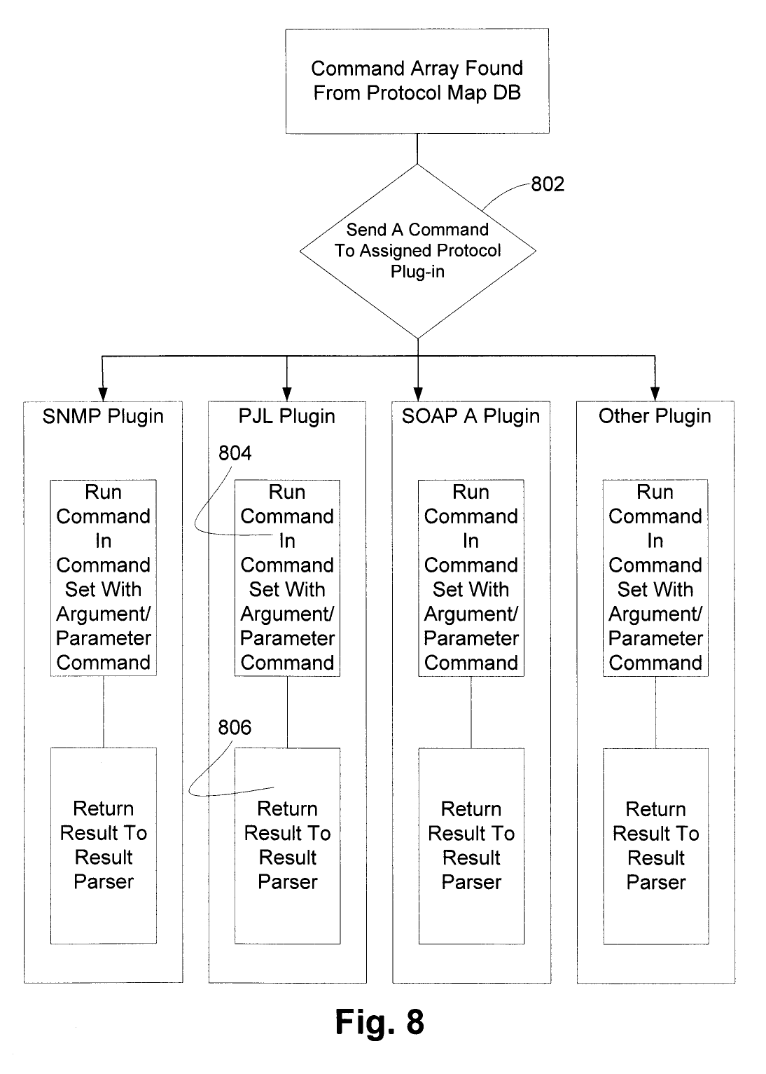

In step 408, once a protocol command or message is determined, it is sent to all of the devices in the Address List, which is a list of all of the known devices on the network. For example, the protocol messages for determining which devices on the network are printers are sent to all of the devices on the network. Further details of step 408 are described below with reference to FIG. 8.

For each protocol message sent in the sending step 408, a corresponding response is received from each device in step 410. The responses are parsed to determine if they match the search term. With reference to the above-described example search term, the response from each device is parsed to determine if it matches “printer.” The name or IP address of each device that matches is stored to a temporary table Xn in step 411, where n is an integer greater than 1.

If no target device type is specified in the search term, the “No” branch of step 402 is followed and all devices on the network and/or all devices on the list are stored to a temporary table Xn in step 404.

The predetermined address list may be a list of known devices on a network, for example. Moreover, devices may be stored in the table Xn by the IP address of the device or by the hostname of the device, for example. That is, in the above-described example search term, table X₁ contains a list of either all devices of the type specified (in this example, a list of all printers) or a list of all of the devices on the network, if no device was specified.

As shown in FIG. 4B, after a list of the devices is stored in the table Xn in step 404 or 411, the PIMS software application checks for “special conditions” in the search term in step 412. An example of a special condition is a “color” or “duplex,” as shown in FIG. 5. In step 414, the PIMS software determines the commands necessary to detect to the specified conditions.

For example, since word set 1 includes the terms “color” and “duplex” as part of the search term, the PIMS software application checks for the commands and protocols that can be used to detect which of the printers listed in table Xn are color, duplex printers. Further details of step 414 are described below with reference to FIGS. 9A and 9B.

Once the commands are determined, the commands are sent to the devices listed in the table Xn in step 416. With reference to the above-described example search term, table X₁ would list the printers detected in step 411, which would include all printers of any type.

That is, the protocol messages for determining which devices on the network are color, duplex printers is sent to the printer devices on the network listed in table X₁. Further details of step 416 are described below with reference to FIG. 8.

For each protocol message sent in the sending step 416, a corresponding response is received from each device. Again, with reference to the above-described example search term, the response from each device is parsed to determine if it matches “color” and “duplex.” An identification of each device that matches the special condition is stored to a temporary table Xn in step 418. This process repeats until all special conditions have been exhausted. In the above-described example search term, table X₁ now contains a list of all printers that are color and duplex. That is, the results of the devices search for word set 1 are now stored in table X₁.

If there are no more special conditions (that is, if either there were no special conditions in the search term, or if they have been exhausted), then the PIMS software checks for a Boolean conditional expression in step 420, indicating a new word set n. If the search term contains a Boolean expression (e.g. a “&&” in the above example), then the PIMS software application checks for the commands that can be used to detect which of the devices listed in table Xn meet the next search term criteria. That is, to return to the above-described example search term, word set 2 is processed. In word set 2, “counter >100,” wherein “counter” is an example of an “evaluable value” and “100” is an example of a “condition value,” as shown in FIG. 5. That is, in step 422, the PIMS application checks for the commands that can be used to detect devices on the network that have the condition “counter >100.” For example, the PIMS application checks for commands necessary to obtain the counter value of each device. Further details of step 422 are described below with reference to FIGS. 9A and 9B.

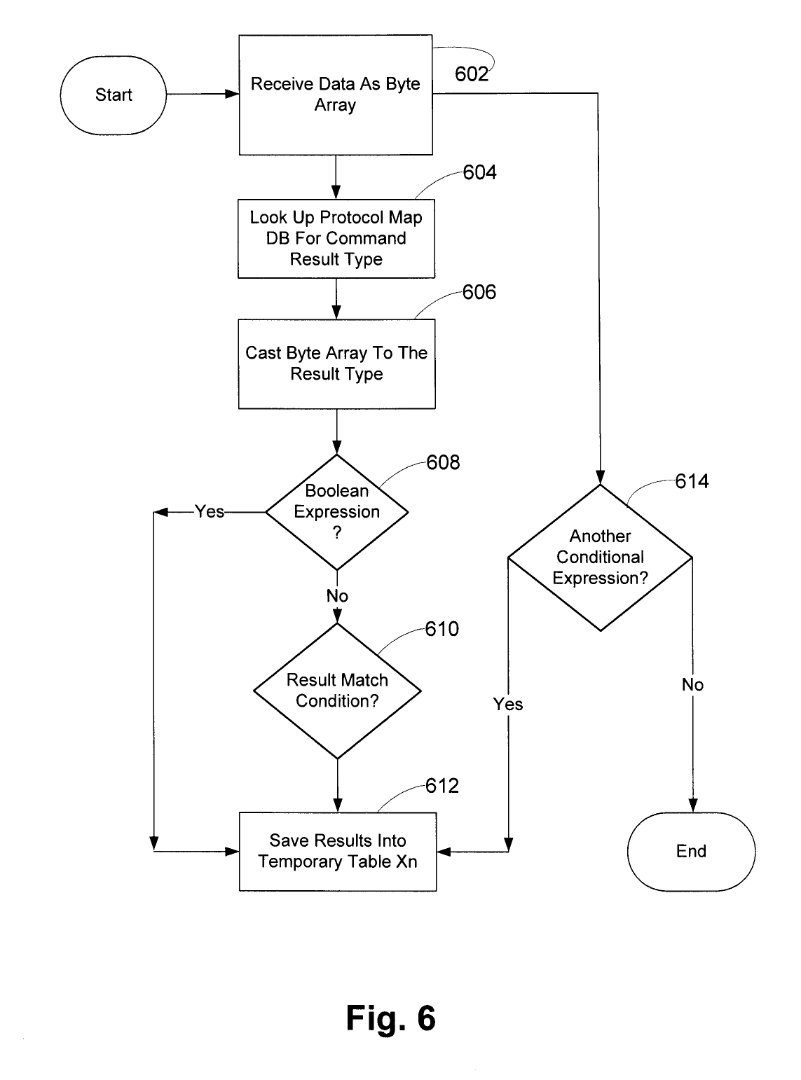

In step 424, once the protocol commands are determined, the commands are sent to the devices listed in the table Xn. Further details of step 424 are described below with reference to FIG. 8. For each protocol message sent in the sending step 424, a corresponding response is received from each device. The responses are parsed to determine devices that match the condition. For example, with reference to the above-described example search term, each device in the list returns its counter value. In step 426, the responses are parsed and compared to the condition value (e.g. >100). Further details of step 426 are described below with reference to FIG. 6.

The results of step 426 (i.e., a list of devices satisfying the condition) are stored to a temporary table Xn in step 428. With reference to the above-described example search term, table X₂ now contains a list of all color, duplex printers with counters greater than 100. That is, the results of the devices search for word set 2 are now stored in table X₂.

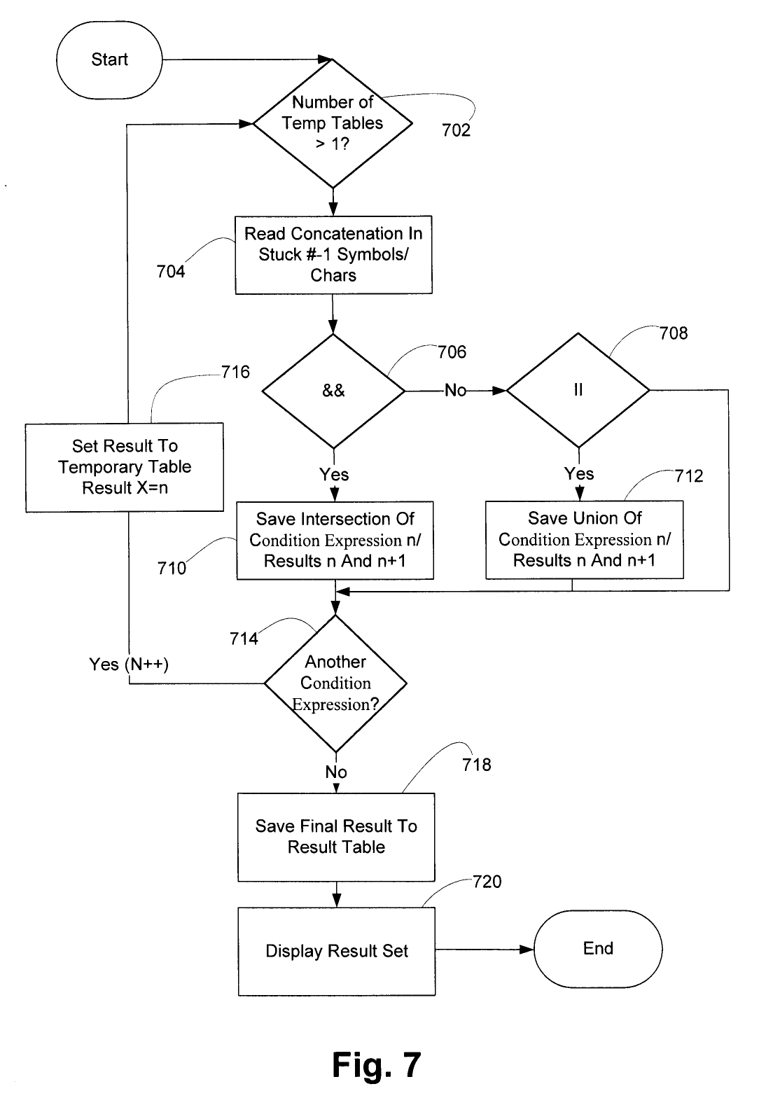

In step 430, it is determined whether there are more word expressions concatenated by a Boolean expression (e.g., “&&” or “∥”). If so, the process returns to step 402 as shown in FIG. 4A. Otherwise, in step 432, if the Boolean expressions have been exhausted, the PIMS application evaluates the result of the temporary tables Xn by union or by intersection of the tables. Further details of step 432 are described below with reference to FIG. 7. In the above example, there are no additional word expressions and no tables that need to be combined by intersection or by union.

The results determined in step 432 are stored to a Results Table 434, which contains a list of the final devices to be displayed to a user as a result of the user device query. The information in the Results Table 434 is displayed. For example, the information in the Results Table 434 may be displayed on display 206 along with related results obtained from the devices.

Further details of step 401 are described below with reference to FIG. 5. FIG. 5 shows an example of how a search term entered by the user is parsed. For example, if the search term is “(printer color duplex && counter >100),” the PIMS application checks for parenthesis, and parses the search term in accordance with the parenthesis in step 502. Then, the PIMS application checks for combination symbols and/or characters, such as Boolean terms “&&” or “∥” in step 504, and the search term is then parsed into word sets n, where n is an integer greater than 1, based on the Boolean expression. Then, the PIMS application evaluates word set n, where n=1. For example, for the search term “printer color duplex && counter >100,” word set 1 is “printer color duplex,” and word set 2 is “counter >100.”

The PIMS application then checks for quotation marks and characters between white spaces and parses the word set accordingly in step 506. Each resulting word is checked for device keywords in step 508 and for Boolean symbols in step 510. For example, as shown in FIG. 5, word set 1 is parsed into Target: “printer” and Special Conditions: “color” and “duplex.” Similarly, word set 2 is parsed into an Evaluable Value: “counter” and Condition Value: “100.”

Further details of step 426 are described below with reference to FIG. 6. FIG. 6 is a flowchart illustrating the process of parsing the data received from accessing a device. The PIMS application receives the data as a byte array in step 602. Then a command type is determined by searching the protocol database in step 604. The byte array is cast to the result type in step 606, the PIMS application checks for a Boolean expression in step 608, and for a matched condition in step 606. The results are saved to a temporary table Xn in step 612. This process is repeated for each condition expression in step 614.

Further details of step 432 are described below with reference to FIG. 7. FIG. 7 is a flowchart illustrating the process of preparing and displaying the search result determined in FIG. 4C. As shown in FIG. 7, a result of the temporary tables Xn is evaluated by a union or by an intersection of the all temporary tables that are generated. More specifically, in step 702, the PIMS application checks if the number of temporary tables is greater than one. If so, the PIMS application reads the concatenations in the search term in step 704. The PIMS application checks for Boolean expressions in steps 706 and 708. The intersection of the condition expressions are saved in step 710 and/or the union of the condition expressions are saved in step 712. The PIMS application checks to see if another condition expression exists in step 714. If so, the process described above (steps 702-712) is repeated and the results are set to a temporary table Result X=n, in step 716. If there are no more condition expressions, the final result is saved to a Result Table in step 702 and the results are displayed in step 720 on a display 206.

Further details of steps 408, 416, and 424 are described below with reference to FIG. 8. FIG. 8 is a flowchart of the process of sending a command to an assigned protocol plug-in. When a command array is found from the protocol map database, a protocol message is generated and a command is sent to an assigned protocol plug-in in step 802. The communication protocols include SNMP, PJL, SOAP, and HTTP, for example. Other protocols can be used. Each protocol has a corresponding plug-in. As shown in FIG. 8, the command is run in a command set with an argument/parameter command in step 804, and a result is returned to the result parser in step 806, where the result parsing step is explained in detail above, with reference to FIG. 6.

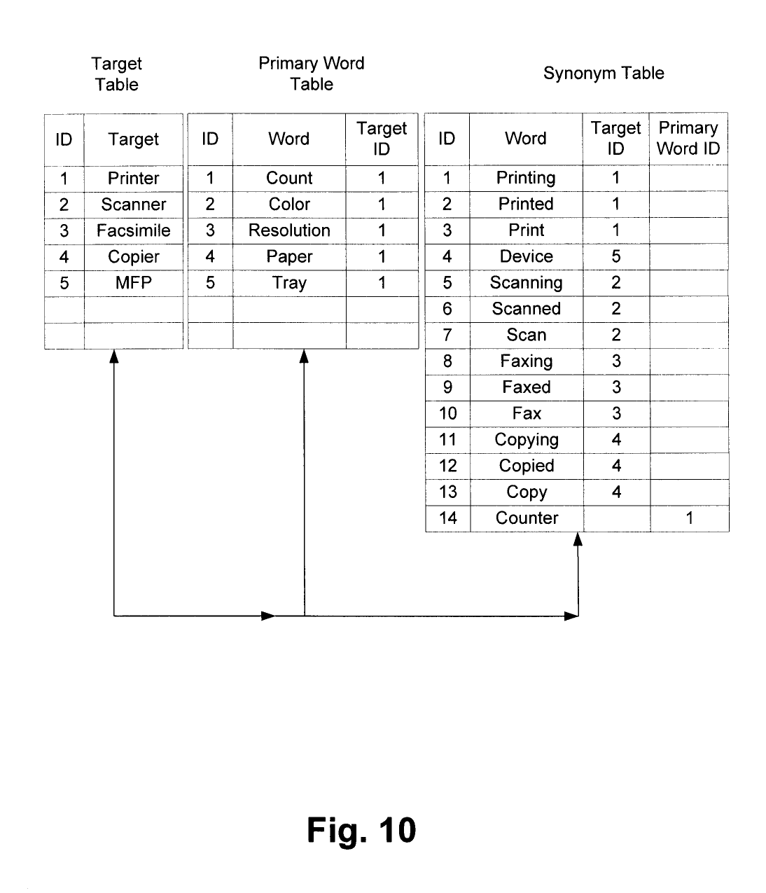

Further details of steps 406, 414, and 422 are described below with reference to FIGS. 9A and 9B. FIGS. 9A and 9B is a flowchart illustrating the process of determining a communication protocol and processing a device to receive information from the device, as seen in FIGS. 4A and 4B. A target table (see, for example, FIG. 10) listing types of target devices is searched for a word matching the search term 902. The target devices can include a printer, a scanner, a facsimile, a copier, and a multifunction printer. In step 904, each match is used to search a target search command table for a command (and corresponding communication protocol) used to identify a target device.

Once the commands are determined, the commands are sent to the devices in the address list in step 906. As discussed above, the address list is a list of all devices on a network, which can be acquired by network discovery tools, such as multi-cast Domain Name System query. The protocol messages for determining which devices are printers, scanners, facsimiles, copiers, or multifunction printers are sent to the devices on the network in step 906. For each protocol message sent in the sending step 906, a corresponding response is received from each device in step 908.

Thereafter, each identified device is stored in a temporary table Xn in step 910. Any unmatched words are stored in a memory in step 912 and all devices in the address list are stored in the temporary table. Then, the PIMS application checks if the temporary table Xn has records in step 914. If records exist, the PIMS application searches a primary word table and/or a synonym table for each term in the search term in steps 916 and 926. See FIG. 10 for an example of a primary word table and a synonym table. For each match, the protocol map database is searched for a command in step 920. The protocol map database includes rules determining the format and transmission of commands and data on the network. The resulting commands are sent to the devices in the address list in step 922. Then, each identified device is stored in the temporary table Xn in step 924.

FIG. 10 illustrates an example of a Target Table, a Word Table, and a Synonym Table.

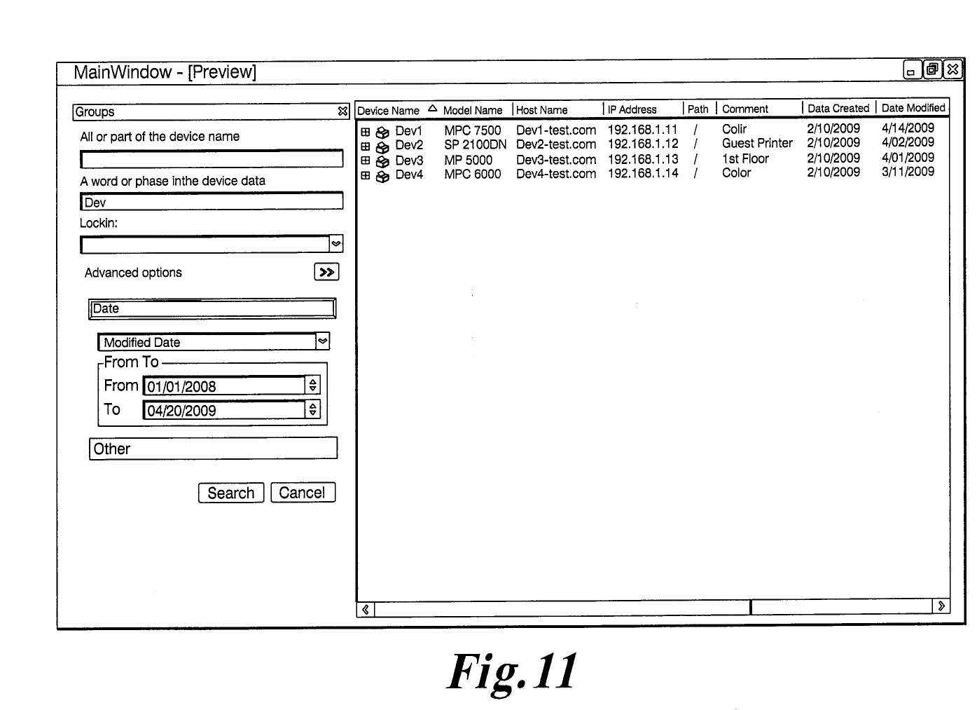

FIG. 11 illustrates an example of a Windows Explorer user interface. The interface includes a field for inputting all or part of a device name. A user may use the notation “*” as a wildcard in combination with the device name, for example. The interface also includes a field for inputting a word of phrase included in the device data, such as the above-described example search term “printer color duplex && counter >100.” The interface also includes a field for inputting where on the network to perform the search, for example, Subnet 1 or a domain name. If this field is not specified, the entire network is searched by default. The interface also includes a field for inputting a specified range of dates to search, the dates indicating a date that a particular device was added to the network. In another field, a user may specify advanced options pertaining to a specific filter, such as “modified data.” When a user clicks the “search” button, a results list is displayed to the user, including the device name, the model name, the host name of the device, the IP address of the device, the path, any comments, the date created, and the date modified.

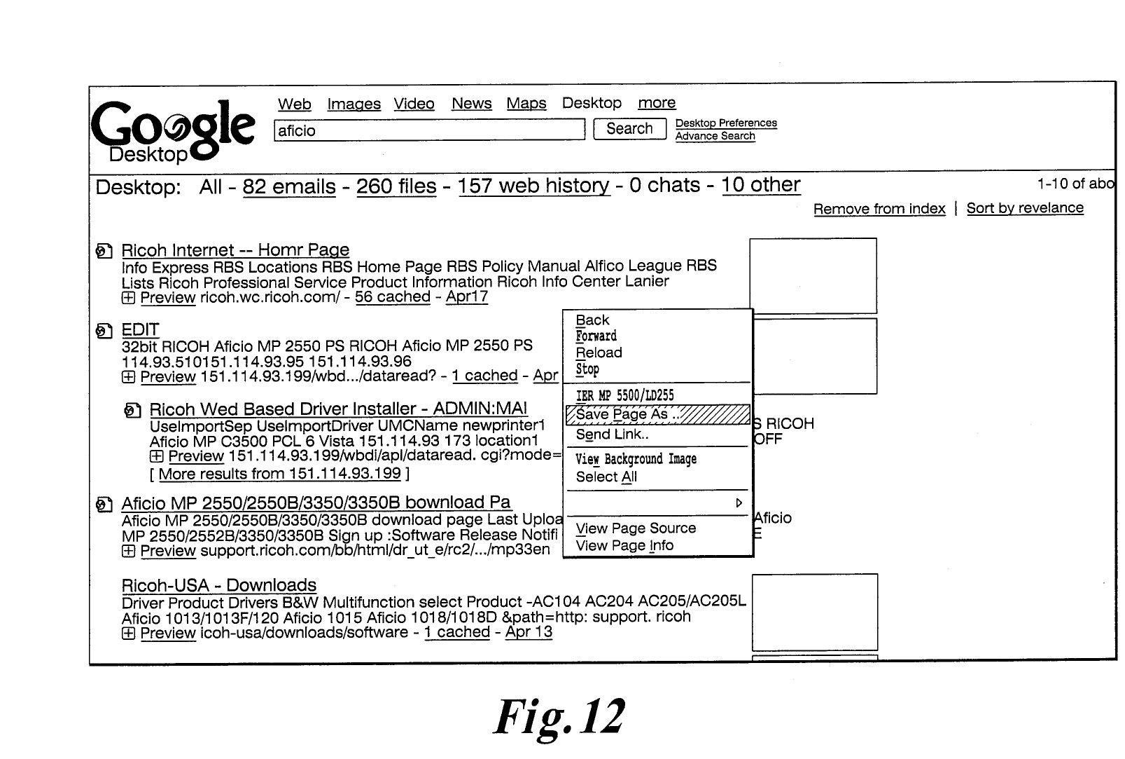

FIG. 12 illustrates an example of search results that are displayed within the Google desktop environment. The interface allows a user to input a search term, such as the above-described example search term “printer color duplex && counter >100,” and displays a result of the search. As noted above, after performing searches, results can also be returned in an Internet browser on the Google Desktop Home Page much like the results for Google Web searches. Further, a user can save the results as an HTML file and export the file to other software applications. For example, a user can export an HTML file of the results to Excel to create a spreadsheet of the results.

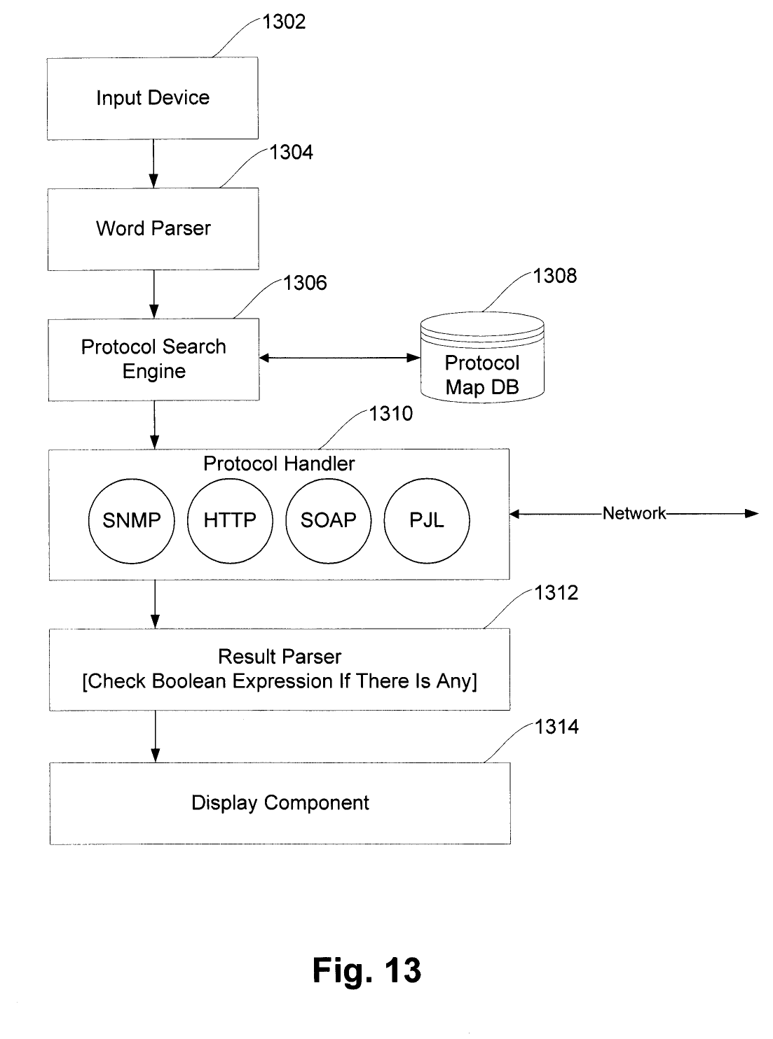

FIG. 13 illustrates a system structure according to one embodiment of the invention. As shown in FIG. 13, the system includes an input device 1302, a word parser 1304, a protocol search engine 1306 for searching protocol database 1308, a protocol handler 1310, a result parser 1312, and a display component 1314. The input device receives a search term from the user, which is then parsed by the word parser to determine one or more word sets. The protocol search engine, the protocol handler, and the result parser perform the functionality described above with respect to FIGS. 4A-10 to determine a final list of devices for display. The display component 1314 is configured to display the final list of devices.

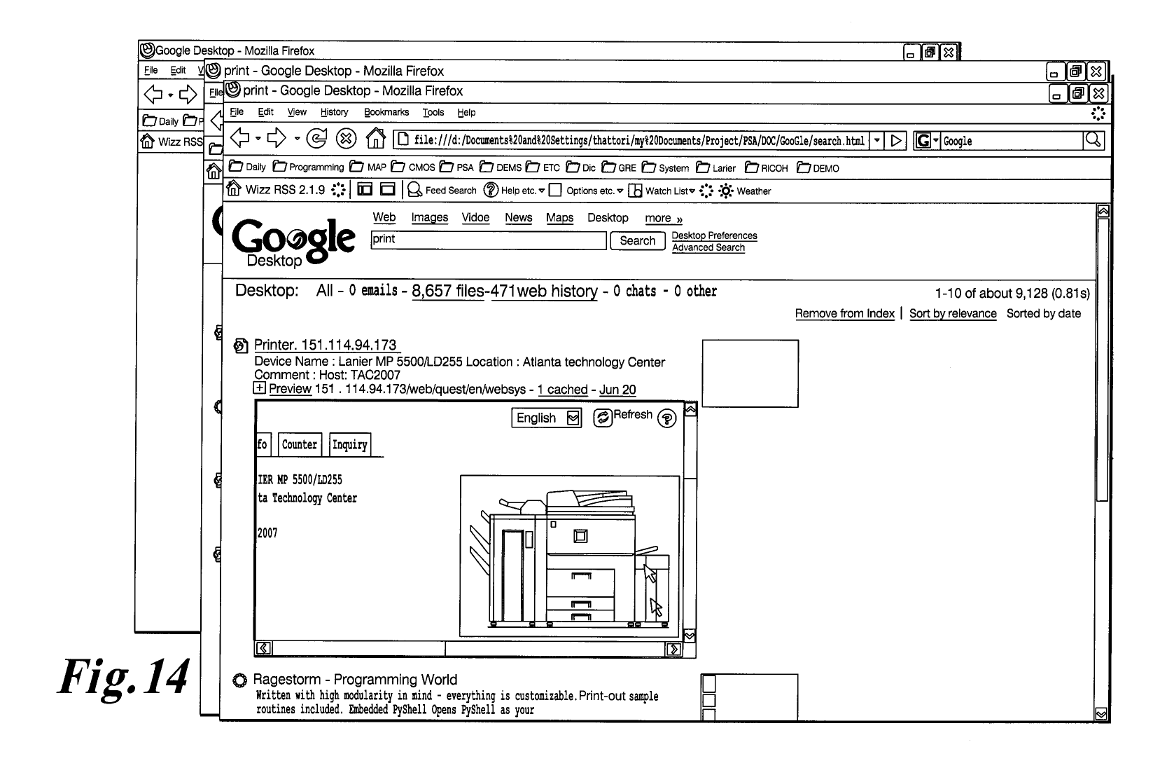

FIG. 14 illustrates another example of Google desktop used in conjunction with the an embodiment of the present invention. A user enters the search term “print” and Google returns the results of a search performed with keyword “print.” For example, the results include a Printer, including the printer's IP address, the device name, the location of the printer, and comments related to the printer. Additionally, device specific information about the printer is displayed. Also displayed in the results are results of the search that a regular “Google search” would return.

Further, Appendix A illustrates an example of the format of a protocol database. Appendix B illustrates an example of a Management Information Base file. Appendix C illustrates an example of Web Services Description Language.

Numerous modifications and variations of the invention are possible in light of the above teachings. It is therefore to be understood that within the scope of the appended claims, the invention may be practiced otherwise than as specifically described herein.

### APPENDIX A

### Protocol Map DB

(Target Map Table May have the Same Format)

Protocol: SNMP

Command ID: xxxxxxx

Command set: SNMP get

Command: OID (xx.xx.xx.xx.xxxx)

Return type: Int

Description: Printer color mode

Protocol: SNMP

Command ID: xxxxxxx

Command set: SNMP get

Command: OID (xx.xx.xx.xx.xxxx)

Return type: Int

Description: The maximum capacity of this supply container/receptacle expressed in SupplyUnit. If this supply container/receptacle can reliably sense this value, the value is sensed by the printer and is read-only; otherwise, the value may be written (by a Remote Control Panel or a Management Application). The value (−1) means other and specifically indicates that the sub-unit places no restrictions on this parameter. The value (−2) means unknown.

Protocol: SNMP

Command ID: yyyyyyyy

Command set: SNMP get

Command: OID (xx.xx.xx.xx.xxxx)

Return type: Int

Description: The current level if this supply is a container; the remaining space if this supply is a receptacle. If this supply container/receptacle can reliably sense this value, the value is sensed by the printer and is read-only; otherwise, the value may be written (by a Remote Control Panel or a Management Application). The value (−1) means other and specifically indicates that the sub-unit places no restrictions on this parameter. The value (−2) means unknown. A value of (−3) means that the printer knows that there is some supply/remaining space, respectively.

Protocol: MULTI

Command ID: xxxxxxx

Command set: Script

Command: xxxxxxx/yyyyyyyy

Return type: Percentage

Description: Printer supply level

Protocol: PJL

Command ID: xxxxxx

Command set: INFO

Command: CONFIG

Return type: String

Description: Obtains configuration information such as paper size types and amounts supported by the printer.

Protocol: SOAP

Command ID: xxxxxxx

Command set: Start session

Command: startsession

Return type: Int

Description: RICOH soap session start method. This returns session id.

1. A method of querying image output devices on a network, comprising:
receiving a search term;
determining if the search term includes a conditional expression;
if the determining step determines that the search term includes a conditional expression, determining which devices in a list of all devices on the network satisfy the conditional expression, so as to generate a final list of devices; and
displaying the final list of devices.

2. The method of claim 1, further comprising:
determining whether the search term includes a target device type;
if the step of determining whether the search term includes a target device type determines that the search term includes the target device type, determining which devices in the list of all devices on the network are of the target device type.

3. The method of claim 2, wherein the step of determining which devices in the list of all devices on the network are of the target device type comprises:
searching a target table listing target device types for a word matching the target device type, the target device type including a printer, a scanner, a facsimile, a copier, and a multifunction printer;
searching a target search command table for the protocol command used to identify a target device type; and
storing each identified device in a temporary table.

4. The method of claim 1, wherein the step of determining which devices in the list of all devices on the network satisfy the conditional expression comprises:
searching a database to determine, based on the conditional expression, a communication protocol and corresponding protocol command for sending to each of the devices on the network;
sending the corresponding protocol command to each device in the list of all devices on the network;
receiving a corresponding response from each device in the list of all devices on the network; and
parsing the responses to determine the final list of devices.

5. The method of claim 4, wherein the sending step comprises:
sending the protocol command to an assigned protocol plug-in and running the protocol command in a command set with an argument/parameter command.

6. The method of claim 4, wherein the step of sending the protocol message comprises sending the protocol message using one of a SNMP, PJL, SOAP, and HTTP protocol.

7. The method of claim 1, wherein the determining step comprises searching at least one of a primary word table and a synonym table for at least one term in the search term.

8. The method of claim 1, further comprising:
generating a spreadsheet of the final list of devices for interfacing with a Google desktop environment.

9. The method of claim 1, wherein the search term is parsed into at least one search key and condition used to query the devices.

10. The method of claim 1, further comprising:
generating the list of all devices on the network by performing a multi-cast Domain Name System query.

11. The method of claim 1, wherein the step of determining which devices in the device list satisfy the conditional expression is repeated for each sub-expression in the conditional expression.

12. An apparatus for querying image output devices on a network, comprising:
a memory storing a list of all devices on the network;
an input device configured to receive a search term;
a word parser configured to parse the received search term;
means for determining if the search term includes a conditional expression; and
means for determining which devices in the list of all devices on the network satisfy the conditional expression, so as to generate a final list of devices, when the means for determining determines that the search term includes a conditional expression.

13. A system for querying image output devices on a network, comprising:
a memory storing a list of all devices on the network;
means for receiving a search term;
means for parsing the received search term;
means for determining if the search term includes a conditional expression;
means for determining which devices in the list of all devices on the network satisfy the conditional expression, so as to generate a final list of devices, when the means for determining determines that the search term includes a conditional expression; and
means for outputting the final list of devices.
